(19) United States
(12) Patent Application Publication
(10) Pub. No.: US 2014/0123651 A1
(43) Pub. Date: May 8, 2014

(54) SYSTEM FOR PROVIDING FUEL TO A COMBUSTOR ASSEMBLY IN A GAS TURBINE ENGINE

(71) Applicant: Ernest W. Smith, Orlando, FL (US)

(72) Inventor: Ernest W. Smith, Orlando, FL (US)

(21) Appl. No.: 13/669,514

(22) Filed: Nov. 6, 2012

(51) Int. Cl. F02C 7/232; F23R 3/02

(52) U.S. Cl. 60/737; 60/734

(57) ABSTRACT

A system for providing fuel to a combustor assembly in a gas turbine engine includes a main fuel valve assembly a plurality of multi-stage combustor valve assemblies. Each multi-stage combustor valve assembly is provided for delivering fuel to a respective combustor of the combustor assembly and includes at least two stage valves, each stage valve in communication with a respective stage within the corresponding combustor. The main fuel valve assembly receives fuel from a source of fuel and selectively delivers the fuel to the plurality of multi-stage combustor valve assemblies. Each stage valve within each multi-stage combustor valve assembly is adjustable to control delivery of fuel to each respective stage.

### FIELD OF THE INVENTION

The present invention relates to system for providing fuel to a combustor assembly in a gas turbine engine, wherein the system includes a plurality of multi-stage valves that can be individually controlled to selectively deliver fuel to stages within the respective combustors of the combustor assembly.

### BACKGROUND OF THE INVENTION

During operation of a gas turbine engine, air is pressurized in a compressor section then mixed with fuel and burned in a combustion section to generate hot combustion gases. In a can annular gas turbine engine, the combustion section comprises an annular array of combustor apparatuses, sometimes referred to as “cans” or “combustors,” which each supply hot combustion gases to a turbine section of the engine where the hot combustion gases are expanded to extract energy therefrom to provide output power, which in turn may be used, for example, to produce electricity.

### SUMMARY OF THE INVENTION

In accordance with a first aspect of the present invention, a system is provided for delivering fuel to a combustor assembly including a plurality of combustors in a gas turbine engine. The system comprises a main fuel valve assembly comprising at least one main fuel valve and a plurality of multi-stage combustor valve assemblies. Each multi-stage combustor valve assembly is provided for delivering fuel to a respective combustor of the combustor assembly and includes at least two stage valves, each stage valve in communication with a respective stage within the corresponding combustor. The main fuel valve assembly receives fuel from a source of fuel and selectively delivers the fuel to the plurality of multi-stage combustor valve assemblies. Each stage valve within each multi-stage combustor valve assembly is adjustable to control delivery of fuel to each respective stage.

In accordance with a second aspect of the present invention, a system is provided for delivering fuel to a combustor assembly in a gas turbine engine. The combustor assembly includes a plurality of combustors, each having at least a first stage comprising a main fuel stage and a second stage comprising a pilot fuel stage. The system comprises a main fuel valve assembly comprising at least one main fuel valve and a corresponding number of multi-stage combustor valve assemblies to the number of combustors in the combustor assembly. Each multi-stage combustor valve assembly is provided for delivering fuel to a respective combustor of the combustor assembly and includes at least first and second multi-position stage valves. The first stage valve is in communication with the first stage within the corresponding combustor and the second stage valve is in communication with the second stage within the corresponding combustor. The system further comprises a controller that controls opening and closing of the at least one main fuel valve and each of the stage valves. The main fuel valve assembly receives fuel from a source of fuel and is controlled by the controller to selectively deliver the fuel to the multi-stage combustor valve assemblies. Each stage valve within each multi-stage combustor valve assembly is independently adjustable by the controller to control the amount of fuel delivered to each respective stage within each respective combustor such that the system is capable of controlling the amount of fuel delivered to each stage within each combustor of the combustor assembly.

In accordance with a third aspect of the present invention, a system is provided for delivering fuel to a can-annular combustor assembly in a gas turbine engine. The combustor assembly includes a plurality of combustors, each having at least a first stage comprising a main fuel stage, a second stage comprising a pilot fuel stage, a third stage comprising a fuel premixing stage for delivering fuel upstream from a main combustion zone of the respective combustor, and a fourth stage comprising a fuel post mixing stage for delivering fuel downstream from the main combustion zone of the respective combustor. The system comprises a main fuel valve assembly comprising at least one main fuel valve and a corresponding number of multi-stage combustor valve assemblies to the number of combustors in the combustor assembly. Each multi-stage combustor valve assembly is provided for delivering fuel to a respective combustor of the combustor assembly and includes at least first, second, third, and fourth multi-position stage valves in communication with the respective first, second, third, and fourth stages within the corresponding combustor. The system further comprises a controller that controls opening and closing of the at least one main fuel valve and each of the stage valves. The main fuel valve assembly receives fuel from a source of fuel and is controlled by the controller to selectively deliver the fuel to the multi-stage combustor valve assemblies. Each stage valve within each multi-stage combustor valve assembly is independently adjustable by the controller to control the amount of fuel delivered to each respective stage within each respective combustor such that the system is capable of controlling the amount of fuel delivered to each stage within each combustor of the combustor assembly.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a side view, partially in section, of a gas turbine engine including a plurality of combustors that each receive fuel from a fuel supply system according to an embodiment of the invention; and

FIG. 2 is a schematic diagram of the fuel supply system and four exemplary combustors of the engine shown in FIG. 1.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

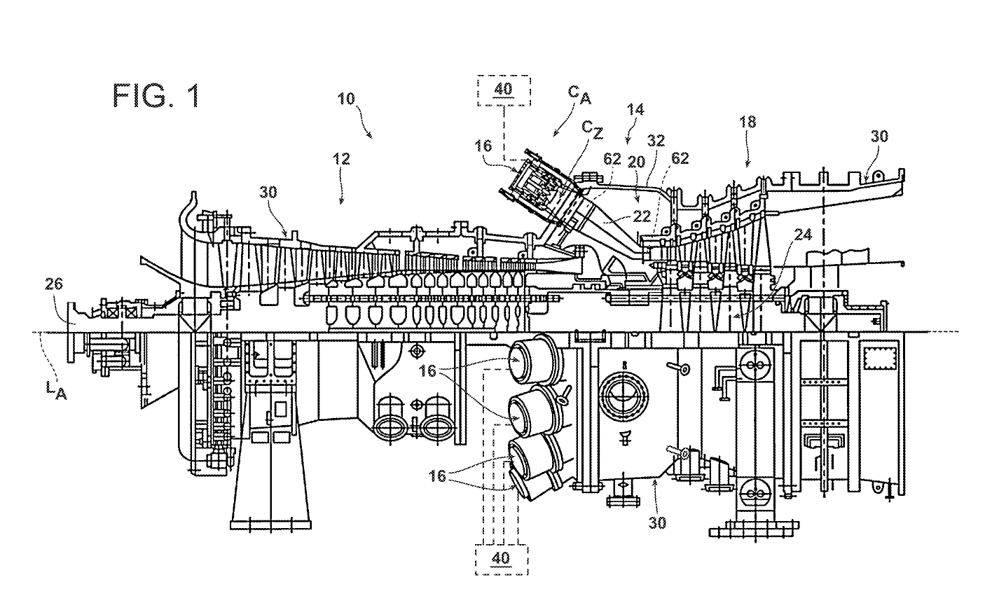

Referring to FIG. 1, a gas turbine engine 10 constructed in accordance with the present invention is shown. The engine 10 includes a compressor section 12, a combustion section 14 including a combustor assembly C_{A} comprising a plurality of combustors 16, and a turbine section 18. It is noted that the combustor assembly C_{A} according to the present invention preferably comprises an annular array of combustors 16 that are disposed about a longitudinal axis L_{A} of the engine 10 that defines an axial direction within the engine 10. Such a configuration is typically referred to as a “can-annular combustor assembly.”

The compressor section 12 inducts and pressurizes inlet air, at least a portion of which is directed to a combustor shell 20 within the combustion section 14 for delivery to the combustors 16. Other portions of the pressurized air may be extracted from the combustion section 12 to cool various components within the engine 10. For example, pressurized air may be bled off from the compressor section 12 and delivered to components in the turbine section 18, as is known in the art.

Upon entering the combustors 16, the compressed air from the combustor shell 20 is mixed with fuel and ignited in a main combustion zone C_{z} to produce high temperature combustion gases flowing in a turbulent manner and at a high velocity within the respective combustor 16. The combustion gases in each combustor 16 then flow through a respective transition duct 22 (only one transition duct 22 is shown in FIG. 1) to the turbine section 18 where the combustion gases are expanded to extract energy therefrom. A portion of the energy extracted from the combustion gases is used provide rotation of a turbine rotor 24, which extends parallel to a rotatable shaft 26 that extends axially through the engine 10 along the longitudinal axis L_{A}.

As shown in FIG. 1, an engine casing 30 is provided to enclose the respective engine sections 12, 14, 18. The portion of the casing 30 surrounding the combustion section 14 comprises a casing wall 32 that defines the combustor shell 20, i.e., the combustor shell 20 defines an interior volume within the portion of the casing 30 that surrounds the combustion section 14.

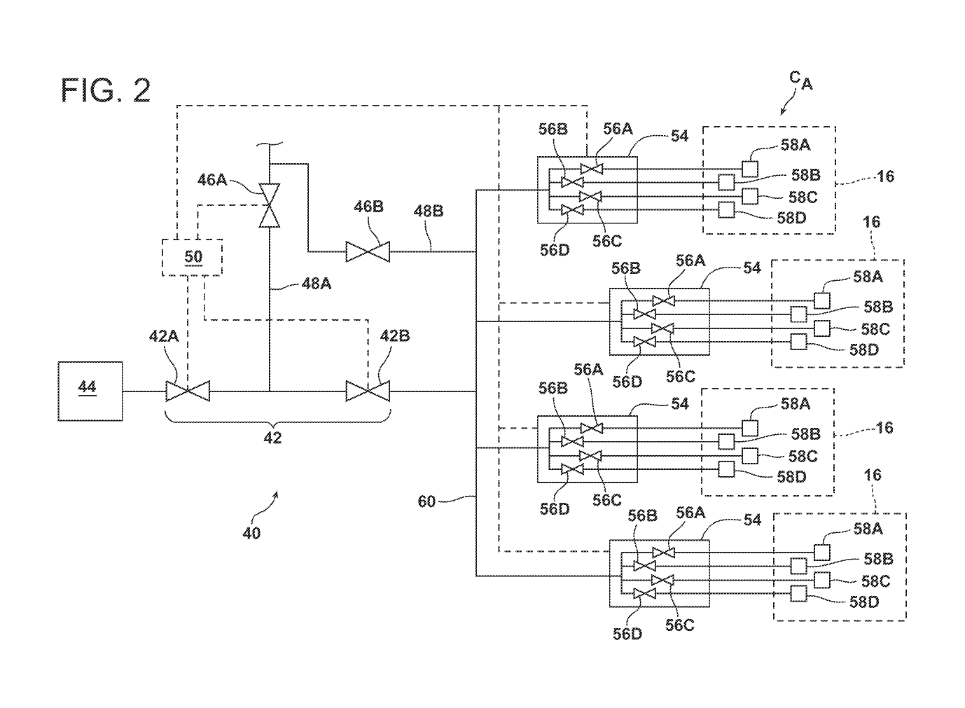

Referring to FIG. 2, a system 40 for providing fuel to the combustor assembly C_{A}, also referred to herein as a fuel supply system, according to an aspect of the present invention will now be described. To reduce the complexity of the fuel supply system 40 shown in FIG. 2, only four of the combustors 16 of the combustor assembly C_{A} are illustrated in FIG. 2. However, it is understood that the system 40 is used to provide fuel to each of the combustors 16 in the combustor assembly C_{A}.

As shown in FIG. 2, the fuel supply system 40 comprises a main fuel valve assembly 42 in communication with a source of fuel 44. The main fuel valve assembly 42 in the embodiment shown comprises first and second main fuel valves 42A, 42B although additional or fewer main fuel valves could be used, i.e., the main fuel valve assembly 42 could include a single main fuel valve or more than two main fuel valves. The first and second main fuel valves 42A, 42B may be multi-position solenoid valves or any other suitable type of valve. The first and second main fuel valves 42A, 42B and the remaining valves of the system 40, which will be described below, are controlled by a system controller 50 as shown in FIG. 2.

According to the embodiment shown, a first vent valve 46A is disposed along a first branch line 48A that is located between the first and second main fuel valves 42A, 42B. The first vent valve 46A is provided for purging fuel from the system 40. For example, the system controller 50 may close the first and second main fuel valves 42A, 42B and open the first vent valve 46A under certain conditions, such as, for example, during engine shutdown, to purge fuel trapped between the first and second main fuel valves 42A, 42B from the system 40. The fuel may be purged to atmosphere or it may be burned in an auxiliary burner (not shown) prior to being released to atmosphere.

The fuel supply system 40 also comprises a plurality of multi-stage combustor valve assemblies 54, and preferably comprises a corresponding number of multi-stage combustor valve assemblies 54 to the number of combustors 16 in the combustor assembly C_{A}. As noted above, the number of combustors 16 and, correspondingly, the number of multi-stage combustor valve assemblies 54 depicted in FIG. 2 have been reduced to four to reduce the complexity of FIG. 2.

Each multi-stage combustor valve assembly 54 delivers fuel to a respective combustor 16 of the combustor assembly C_{A}. In the embodiment shown in FIG. 2, each multi-stage combustor valve assembly 54 includes four stage valves 56A, 56B, 56C, 56D, although the multi-stage combustor valve assemblies 54 could include additional or fewer stage valves. In the preferred embodiment illustrated in FIG. 2, each multi-stage combustor valve assembly 54 comprises a corresponding number of stage valves 56A-D to the number of stages 58A-D in the corresponding combustor 16. The exemplary stages of the combustors 16 depicted in FIG. 2 include a pilot stage 58A that delivers fuel to the corresponding combustor 16 to produce a pilot flame, a main stage 58B that delivers a majority of the fuel to each combustor 16 for the production of hot combustion gases within the corresponding combustor 16, a fuel premixing stage 58C for delivering fuel upstream from the main combustion zone C_{Z} of the respective combustor 16, and a fuel post mixing stage 58D for delivering fuel downstream from the main combustion zone C_{Z} of the respective combustor 16.

As shown in FIG. 2, each stage valve 56A-D in each multi-stage combustor valve assembly 54 is in communication with a respective stage 58A-D within the corresponding combustor 16. The stage valves 56A-D are preferably multi-position solenoid valves and are controlled by the system controller 50. As will be discussed below, the stage valves 56A-D can be independently adjusted by the system controller 50 to selectively control the amount of fuel delivered to each respective stage 58A-D within each respective combustor 16, such that the fuel supply system 40 is capable of controlling the amount of fuel delivered to each stage 58A-D within each combustor 16 of the combustor assembly C_{A}.

It is noted that each multi-stage combustor valve assembly 54 preferably comprises at least two stage valves, wherein the first stage valve 56A is in communication with the pilot stage 58A and the second stage valve 56B is in communication with the main stage 58B. Additional stage valves in communication with additional stages, which could be premixing stages, post mixing stages, or any other type of fuel stage associated with the combustors 16, could also be included in each multi-stage combustor valve assembly 54 as desired.

Referring still to FIG. 2, the fuel supply system 40 further comprises a fluid circuit 60 that provides fluid communication between the main fuel valve assembly 42 and the multi-stage combustor valve assemblies 54, i.e., the fluid circuit 60 is used to deliver fuel from the main fuel valve assembly 42 to each of the multi-stage combustor valve assemblies 54. A second branch line 48B including a second vent valve 46B is included in the fluid circuit 60. The second vent valve 46B is provided for purging fuel from the system 40. For example, the system controller 50 may close the main fuel valve assembly 42, i.e., at least the second main fuel valve 42B in the embodiment shown, and open the second vent valve 46B during certain conditions to purge fuel from the system 40 that is trapped in the fluid circuit 60 between the second main fuel valve 42A the multi-stage combustor valve assemblies 54. As noted above, the fuel may be purged to atmosphere or it may be burned in an auxiliary burner (not shown) prior to being released to atmosphere.

As noted above, the main fuel valve assembly 42 could include only a single main fuel valve. In such a configuration, the first vent valve 46A and the first branch line 48A could be eliminated from the system 40, and the second vent valve 48B, which would be located in the fluid circuit 60 downstream from the single main fuel valve, could handle any fuel purging that was desired.

A method for utilizing the fuel supply system 40 to deliver fuel to the combustor assembly C_{A} will now be described. During operation of the engine 10, the main fuel valve assembly 42 is controlled by the system controller 50 to selectively provide fuel to each of the multi-stage combustor valve assemblies 54. The system controller 50 also controls the multi-stage combustor valve assemblies 54 to deliver the fuel to the respective combustors 16, which combust the fuel with air from the combustor shell 20 to create hot combustion gases as discussed above.

During operation of the engine 10, it may be detected that certain stages 58A-D in certain combustors 16 require more or less fuel, such that generally uniform conditions are present among the combustors 16. Such conditions may be sensed, for example, by one or more sensors 62 (see FIG. 1), which may be located, for example, within the respective combustors 16 or downstream from the respective transition ducts 22, either before or after reaching the rotating components within the turbine section 18.

As a first example, one or more of the sensors 62 may be thermocouples that sense combustion gas temperature within the respective combustors 16. Such sensors 62 may detect that the combustion gases within one or more of the combustors 16 are too hot or too cold. In such a scenario, the system controller 50 may adjust, for example, the second stage valve 56B of the corresponding multi-stage combustor valve assembly(ies) 54 to change the amount of fuel provided to the main stage 58B within the corresponding combustor(s) 16 so as to increase/decrease the amount of combustion gas created in the respective combustor 16, thus resulting in a corresponding temperature adjustment of the combustion gas within the corresponding combustor(s) 16. Hence, the fuel supply system 40 may be used to create a generally uniform temperature for the combustion gas produced by each respective combustor 16.

As a second example, one or more of the sensors 62 may be flow rate sensors that sense an amount of combustion gas produced by each respective combustor 16. Such sensors 62 may detect that combustion gas production within one or more of the combustors 16 is too high or too low. In such a scenario, the system controller 50 may adjust, for example, the second stage valve 56B of the corresponding multi-stage combustor valve assembly(ies) 54 to change the amount of fuel provided to the main stage 58B within the corresponding combustor(s) 16 so as to increase/decrease the amount of combustion gas created in the respective combustor 16. Hence, the fuel supply system 40 may be used to create a generally uniform amount of combustion gas produced by each respective combustor 16.

As a third example, one or more of the sensors 62 may be emissions sensors that sense emissions given off by the combustion taking place within the respective combustors 16. Such sensors 62 may detect that the emissions, e.g., CO, NOx, etc., given off by combustion occurring within one or more of the combustors 16 are out of specification. In such a scenario, the system controller 50 may adjust, for example, the third and/or fourth stage valves 56C, 56D of the corresponding multi-stage combustor valve assembly(ies) 54 to change the amount of fuel provided to the third and/or fourth stages 58C, 58D within the corresponding combustor(s) 16 so as to adjust the emissions given off by combustion occurring within the corresponding combustor(s) 16. Hence, the fuel supply system 40 may be used to fine tune emissions given off by combustion occurring within each respective combustor 16.

It is noted that changing the amount of fuel provided to the exemplary stages within the combustors 16 as described in the three scenarios provided above are examples of ways to change the operating conditions within the combustors 16, and alternate strategies may be used. For example, changing the amounts of fuel provided to additional or alternate stages 58A-D than those described above may be used to change the operating conditions within the combustors 16.

The fuel supply system 40 according to the present invention is able to control total fuel flow to each combustor 16 by controlling the stage valves 56A-D within each-stage combustor valve assembly 54, and is also able to individually and finely tune fuel flow to the individual stages 58A-D of each of the respective combustors 16 so as to provide maximum refinement of a fuel ratio to each stage 58A-D within each combustor 16. Further, fuel flow to one or more combustors 16 is able to be entirely cut off by the system 40, i.e., by closing all of the stage valves 56A-D of the multi-stage combustor valve assembly 54 associated with the select combustor(s) 16.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for providing fuel to a combustor assembly including a plurality of combustors in a gas turbine engine comprising:
a main fuel valve assembly comprising at least one main fuel valve; and
a plurality of multi-stage combustor valve assemblies, each multi-stage combustor valve assembly provided for delivering fuel to a respective combustor of the combustor assembly and including at least two stage valves, each stage valve in communication with a respective stage within the corresponding combustor;
wherein the main fuel valve assembly receives fuel from a source of fuel and selectively delivers the fuel to the plurality of multi-stage combustor valve assemblies; and
wherein each stage valve within each multi-stage combustor valve assembly is adjustable to control delivery of fuel to each respective stage.

2. The system of claim 1, further comprising a controller that is provided to control opening and closing of the at least one main fuel valve and the stage valves.

3. The system of claim 1, further comprising at least one vent valve for selectively purging fuel from the system.

4. The system of claim 3, wherein:
the main fuel valve assembly comprises a first main fuel valve and a second main fuel valve; and
a vent valve is located between the first and second main fuel valves.

5. The system of claim 3, further comprising a fluid circuit for providing fuel from the main fuel valve assembly to the multi-stage combustor valve assemblies, wherein a vent valve is provided in the fluid circuit.

6. The system of claim 1, wherein:
each combustor comprises a first stage comprising a main fuel stage and a second stage comprising a pilot fuel stage; and
each multi-stage combustor valve assembly includes first and second stage valves, the first stage valve in communication with the first stage and the second stage valve in communication with the second stage.

7. The system of claim 6, wherein each combustor further comprises a third stage comprising one of:
a fuel premixing stage for delivering fuel upstream from a main combustion zone of the respective combustor; and
a fuel post mixing stage for delivering fuel downstream from the main combustion zone of the respective combustor.

8. The system of claim 7, wherein each multi-stage combustor valve assembly includes a third stage valve in communication with the third stage.

9. The system of claim 1, wherein the combustor assembly comprises a can annular combustion assembly and the system comprises corresponding number of multi-stage combustor valve assemblies to the number of combustors in the combustor assembly.

10. The system of claim 1, wherein the stage valves are multi-position solenoid valves and each stage valve within each multi-stage combustor valve assembly is independently adjustable to control the amount of fuel delivered to each respective stage within each respective combustor such that the system is capable of controlling the amount of fuel delivered to each stage within each combustor of the combustor assembly.

11. A system for providing fuel to a combustor assembly in a gas turbine engine, the combustor assembly including a plurality of combustors, each having at least a first stage comprising a main fuel stage and a second stage comprising a pilot fuel stage, the system comprising:
a main fuel valve assembly comprising at least one main fuel valve;
a corresponding number of multi-stage combustor valve assemblies to the number of combustors in the combustor assembly, each multi-stage combustor valve assembly provided for delivering fuel to a respective combustor of the combustor assembly and including at least first and second multi-position stage valves, the first stage valve in communication with the first stage within the corresponding combustor and the second stage valve in communication with the second stage within the corresponding combustor; and
a controller that controls opening and closing of the at least one main fuel valve and each of the stage valves;
wherein the main fuel valve assembly receives fuel from a source of fuel and is controlled by the controller to selectively deliver the fuel to the multi-stage combustor valve assemblies; and
wherein each stage valve within each multi-stage combustor valve assembly is independently adjustable by the controller to control the amount of fuel delivered to each respective stage within each respective combustor such that the system is capable of controlling the amount of fuel delivered to each stage within each combustor of the combustor assembly.

12. The system of claim 11, further comprising at least one vent valve for selectively purging fuel from the system.

13. The system of claim 12, wherein:
the main fuel valve assembly comprises a first main fuel valve and a second main fuel valve; and
a vent valve is located between the first and second main fuel valves and is used to purge fuel trapped between the first and second main fuel valves when they are closed.

14. The system of claim 12, further comprising a fluid circuit for providing fuel from the main fuel valve assembly to the multi-stage combustor valve assemblies, wherein a vent valve is provided in the fluid circuit for purging fuel from the fluid circuit when the at least one main fuel valve and the stage valves are closed.

15. The system of claim 11, wherein each combustor further comprises a third stage comprising one of:
a fuel premixing stage for delivering fuel upstream from a main combustion zone of the respective combustor; and
a fuel post mixing stage for delivering fuel downstream from the main combustion zone of the respective combustor.

16. The system of claim 15, wherein each multi-stage combustor valve assembly further includes a third stage valve in communication with the third stage.

17. The system of claim 11, wherein each combustor further comprises:
a third stage comprising a fuel premixing stage for delivering fuel upstream from a main combustion zone of the respective combustor; and
a fourth stage comprising a fuel post mixing stage for delivering fuel downstream from the main combustion zone of the respective combustor.

18. The system of claim 17, wherein each multi-stage combustor valve assembly further includes a third stage valve in communication with the third stage and a fourth stage valve in communication with the fourth stage.

19. A system for providing fuel to a can-annular combustor assembly in a gas turbine engine, the combustor assembly including a plurality of combustors, each having at least a first stage comprising a main fuel stage, a second stage comprising a pilot fuel stage, a third stage comprising a fuel premixing stage for delivering fuel upstream from a main combustion zone of the respective combustor, and a fourth stage comprising a fuel post mixing stage for delivering fuel downstream from the main combustion zone of the respective combustor, the system comprising:
a main fuel valve assembly comprising at least one main fuel valve;
a corresponding number of multi-stage combustor valve assemblies to the number of combustors in the combustor assembly, each multi-stage combustor valve assembly provided for delivering fuel to a respective combustor of the combustor assembly and including at least first, second, third, and fourth multi-position stage valves in communication with the respective first, second, third, and fourth stages within the corresponding combustor; and
a controller that controls opening and closing of the at least one main fuel valve and each of the stage valves;
wherein the main fuel valve assembly receives fuel from a source of fuel and is controlled by the controller to selectively deliver the fuel to the multi-stage combustor valve assemblies; and
wherein each stage valve within each multi-stage combustor valve assembly is independently adjustable by the controller to control the amount of fuel delivered to each respective stage within each respective combustor such that the system is capable of controlling the amount of fuel delivered to each stage within each combustor of the combustor assembly.

20. The system of claim 19, wherein:
the main fuel valve assembly comprises a first main fuel valve and a second main fuel valve;
a first vent valve is located between the first and second main fuel valves and is used to purge fuel trapped between the first and second main fuel valves when they are closed;
the system further comprises a fluid circuit for providing fuel from the second main fuel valve to the multi-stage combustor valve assemblies; and
a second vent valve is provided in the fluid circuit for purging fuel from the fluid circuit when the second main fuel valve and the stage valves are closed.
